(19) United States
(12) Patent Application Publication
(10) Pub. No.: US 2024/0289654 A1
(43) Pub. Date: Aug. 29, 2024

(54) ELECTRONIC DEVICE AND OPERATION METHOD OF ELECTRONIC DEVICE FOR PERFORMING CALCULATION USING ARTIFICIAL INTELLIGENCE MODEL

(71) Applicant: Samsung Electronics Co., Ltd., Suwon-si (KR)

(72) Inventors: Jungbae KIM, Suwon-si (KR); Mooyoung KIM, Suwon-si (KR); Seungjin KIM, Suwon-si (KR); Euntaik LEE, Suwon-si (KR); Jungeun LEE, Suwon-si (KR); Hyeonsu LEE, Suwon-si (KR)

(21) Appl. No.: 18/599,852

(22) Filed: Mar. 8, 2024

Related U.S. Application Data
(63) Continuation of application No. PCT/KR2024/002255, filed on Feb. 21, 2024.

(30) Foreign Application Priority Data
Feb. 23, 2023 (KR) 10-2023-0024414
Mar. 24, 2023 (KR) 10-2023-0038744

(51) Int. Cl. G06N 5/04

(52) U.S. Cl. CPC G06N 5/04

(57) ABSTRACT

An electronic device is provided. The electronic device includes memory storing artificial intelligence models and one or more programs including instructions, and one or more processor, wherein the one or more programs including instructions, when executed by the one or more processors, cause the electronic device to load the artificial intelligence models stored in memory and execute a runtime engine of a framework, identify whether an operation function is supported on a target processor, identify whether a first node for executing an inference on the artificial intelligence models operate without errors based on supporting the operation function on the target processor, repeat the identification until a last node by adding one more nodes in case that the first node operates without errors, form a first group by creating a partition from the first node to an identified N−1st node based on the identification that an error occurred on an Nth node, and form a second group by creating a partition for the Nth node on which the error occurred.

### CROSS-REFERENCE TO RELATED APPLICATION(S)

This application is a continuation application, claiming priority under § 365(c), of an International application No. PCT/KR2024/002255, filed on Feb. 21, 2024, which is based on and claims the benefit of a Korean patent application number 10-2023-0024414, filed on Feb. 23, 2023, in the Korean Intellectual Property Office, and of a Korean patent application number 10-2023-0038744, filed on Mar. 24, 2023, in the Korean Intellectual Property Office, the disclosure of each of which is incorporated by reference herein in its entirety.

### TECHNICAL FIELD

This document relates to electronic devices. More particularly, the disclosure relates to electronic devices that perform calculations using artificial intelligence models and methods for operating electronic devices.

### BACKGROUND ART

Artificial neural network (ANN) refers to a computational architecture that models the biological brain. Based on artificial neural networks, deep learning or machine learning can be implemented. As an example of an artificial neural network, deep neural network or deep learning may have a multi-layer structure including a plurality of layers.

Artificial intelligence models (AI models) are being used in various ways to analyze visual and audio information. To effectively operate the artificial intelligence model in the mobile terminal, research and development on hardware technology related to the artificial intelligence model is actively progressing. For example, not only multiply-accumulate (MAC) calculation optimization research performed on deep learning artificial intelligence models, but also hardware structure improvement technologies considering artificial intelligence models are being studied and applied.

In addition, the data processing system includes at least one processor generally known as a central processing unit (CPU). Such a data processing system may also include at least one other processor, such as a neural processing unit (NPU), used for various types of specialized processing.

The above information is presented as background information only to assist with an understanding of the disclosure. No determination has been made, and no assertion is made, as to whether any of the above might be applicable as prior art with regard to the disclosure.

### DISCLOSURE OF INVENTION

Artificial intelligence learning models may be constructed and trained in the form of complex graphs. Referring to FIGS. 3A and 3B, one learning model may have a large number of nodes (e.g., 100,000). The AI learning model may compile or interpret to handle a large number of nodes (e.g., 100,000) in the backend. At this time, in the backend of the artificial intelligence learning model, the required memory becomes larger than the size of the memory available on the actual electronic device, and it may be difficult to compile or interpret normally.

Aspects of the disclosure are to address at least the above-mentioned problems and/or disadvantages and to provide at least the advantages described below. Accordingly, an aspect of the disclosure is to provide an electronic device that performs calculation using the artificial intelligence model according to this document aims to separate the nodes and control them to perform normal compiling or interpreting on the artificial intelligence learning model using a plurality of partitions instead of a single partition.

Additional aspects will be set forth in part in the description which follows and, in part, will be apparent from the description, or may be learned by practice of the presented embodiments.

In accordance with an aspect of the disclosure, an electronic device is provided. The electronic device includes memory storing artificial intelligence models and one or more programs including instructions, and one or more processors, wherein the one or more programs including instructions, when executed by the one or more processors, cause the electronic device to load the artificial intelligence models stored in memory and execute a runtime engine of a framework, identify whether an operation function is supported on the target processor, identify whether a first node for executing inference on the artificial intelligence models operate without errors based on supporting the operation function on the target processor, repeat the identification until a last node by adding one more nodes in case that the first node operates without errors, form the first group by creating a partition from the first node to an identified N−1st node based on the identification that an error occurred on an Nth node, and form a second group by creating for the Nth node on which the error occurred.

In accordance with an aspect of the disclosure, an electronic device is provided. The electronic device includes memory storing artificial intelligence models and one or more programs including instructions; and one or more processors, wherein the one or more programs including instructions, when executed by the one or more processors, cause the electronic device to load the artificial intelligence models stored in the memory and execute a runtime engine of a framework, obtain information about hardware of the electronic device, identify whether an operation function is supported on a target processor, identify whether a first node for executing an inference on the artificial intelligence models operate without errors based on supporting the operation function on the target processor, repeat the identification until a last node by adding one more nodes based on the identification being successful, form a first group by creating a partition from the first node to an identified N−1st node based on the identification not being successful in a Nth node, identify whether the Nth node operates without errors, repeat the identification until the last node by adding the one more nodes based on the Nth node operating without errors, and form a second group by creating a partition from the Nth node to an identified K−1st node based on a Kth node on which the error occurred, repeat the identification until the last node whether the error occurs, wherein the N and the K are natural numbers, and wherein the K is greater than the N.

In accordance with yet another aspect of the disclosure, a method of operating an electronic device is provided. The operating method of the electronic device includes loading the artificial intelligence model stored in memory to execute a runtime engine of a framework, identifying whether a target processor supports an operation function, identifying whether a first node for executing an inference on the artificial intelligence model operates without errors based on supporting an operation function on the target processor, repeating the identification until a last node by adding one more nodes in case that the first node operates without errors, forming a first group by creating a partition from the first node to an identified N−1st node based on an error occurring on an Nth node, and forming the second group by creating for the Nth node on which the error occurred.

An electronic device that performs calculation using an artificial intelligence model according to this document may separate nodes using a plurality of partitions rather than a single partition. Through this operation, the electronic device can control to compile or interpret normally on the artificial intelligence learning model despite the limitation of the actual memory size.

In accordance with yet another aspect of the disclosure, one or more non-transitory computer-readable storage media storing one or more programs including instructions that, when executed by one or more processors of an electronic device, cause the electronic device to perform operations are provided. The operations include loading an artificial intelligence model stored in memory and executing a runtime engine of a framework, identifying whether an operation is supported on a target processor, identifying whether a first node for executing an inference on the artificial intelligence model operates without errors based on supporting the operation on the target processor, repeating the identification until a last node by adding one more nodes based on the first node operating without errors, forming a first group by creating a partition from the first node to an identified N−1st node, forming a second group by creating a partition for an Nth node on which an error occurred, and storing instructions that repeatedly identify whether the inference is executed without errors on the artificial intelligence model from an N+1th node to the last node.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A and 2B is a diagram of an example of a neural network (NN) structure according to various embodiments of the disclosure;

FIGS. 3A and 3B illustrate the process of sequentially inferring through the partition of each node in an artificial intelligence learning model according to various embodiments of the disclosure;

FIG. 4 illustrates a layer of an electronic device that automatically generates partitions between nodes for calculation according to an embodiment of the disclosure;

FIG. 5A illustrates a first embodiment that automatically generates partitions between nodes for computation according to an embodiment of the disclosure;

FIG. 5B illustrates the process for the first embodiment as a flowchart according to an embodiment of the disclosure;

FIG. 5C illustrates the process for the first embodiment as a flowchart according to an embodiment of the disclosure;

FIG. 6A illustrates a second embodiment that automatically generates partitions between nodes for computation according to an embodiment of the disclosure;

FIG. 6B illustrates the process for the second embodiment as a flowchart according to an embodiment of the disclosure; and

FIG. 7 illustrates a flowchart of a method of performing calculation of an electronic device according to an embodiment of the disclosure;

### Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

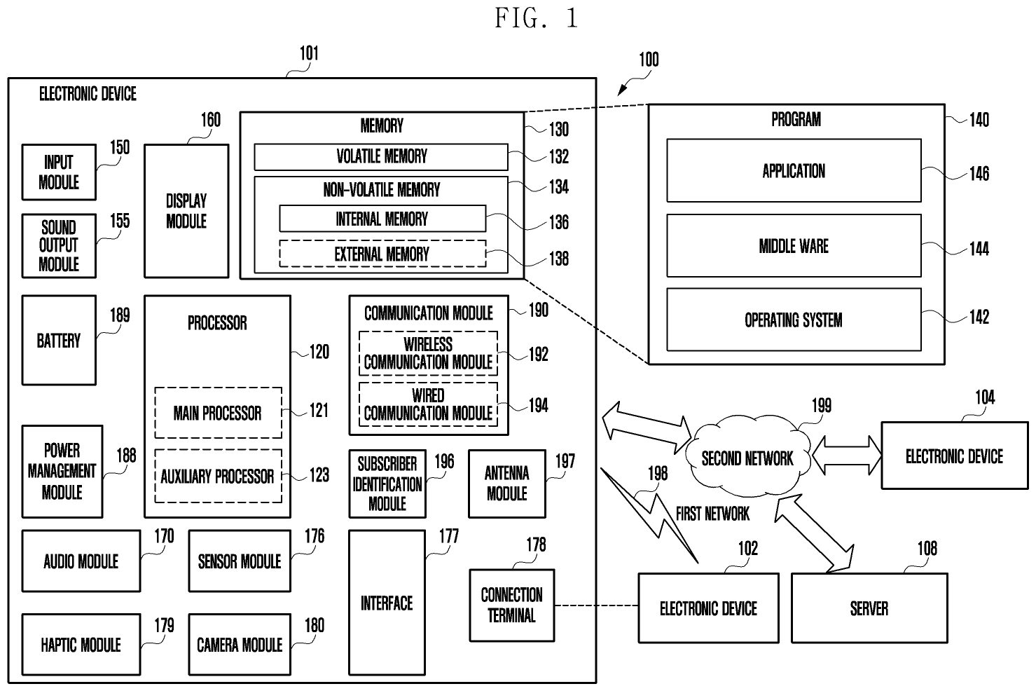

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added. in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing. or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 G gigabits per second (bps) or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108 For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A , B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

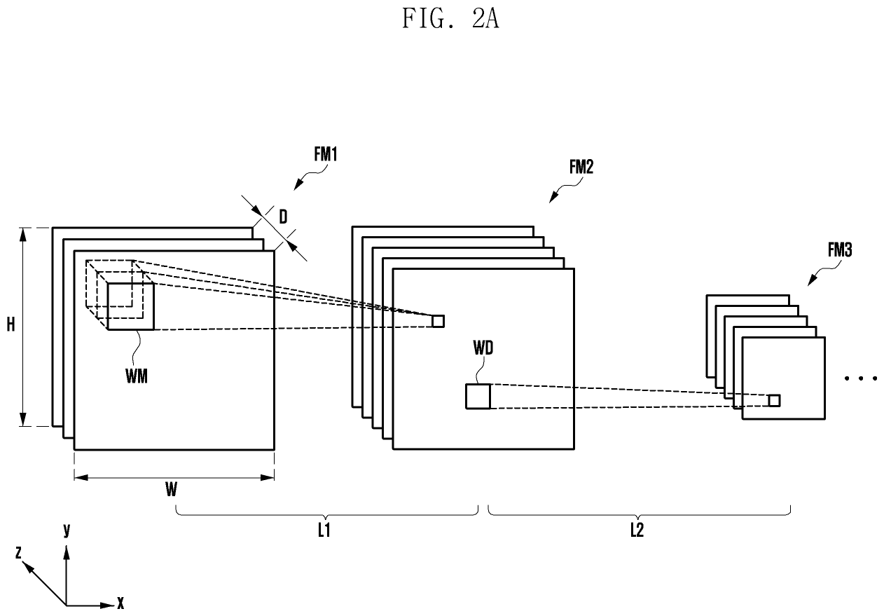

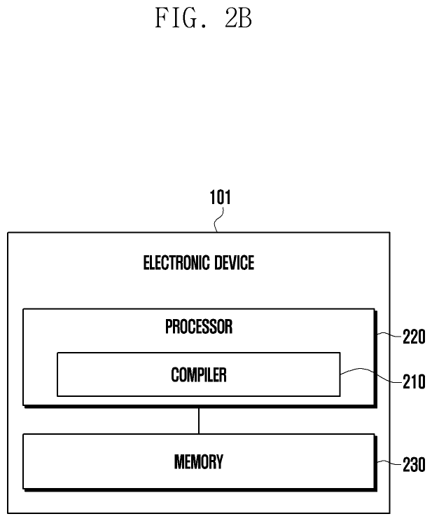

FIGS. 2A and 2B is a diagram of an example of a neural network (NN) structure according to various embodiments of the disclosure.

In the description related to FIGS. 2A and 2B, the operation of the model or the layer may be understood as the operation of the central processing unit (CPU) and/or the neural processing unit (NPU).

For example, the first layer L1 may be a convolution layer and the second layer L2 may be a sampling layer. The artificial neural network model may include more activation layers, and may include more layers that perform other kinds of calculations.

Each of the plurality of layers may receive input image data or a feature map generated in the previous layer as an input feature map, and may generate an output feature map by calculating the input feature map. In this case, the feature map may mean data in which various features of the input data are expressed. Feature maps FM1, FM2, and FM3 may have, for example, a two-dimensional matrix or a three-dimensional matrix form. The feature maps FM1 to FM3 have width W (or called column), height H (or called row) and depth D, which may correspond to the x-axis, y-axis, and z-axis, respectively, on the coordinates. In this case, the depth D may be referred to as the number of channels.

The first layer L1 may generate a second feature map FM2 by convolving the first feature map FM1 with the weight map WM. The weight map WM may filter the first feature map FM1 and may be referred to as a filter or a kernel. For example, the depth of the weight map WM, that is, the number of channels, is equal to the depth of the first feature map FM1, for example, the number of channels, and the weight map WM and the first feature map FM1 may be convolved between the same channels. The weight map WM may be shifted in such a way as to traverse the first feature map FM1 as a sliding window. The amount shifted may be referred to as a “stride length” or a “stride”. During each shift, each of the weights included in the weight map WM may be multiplied and added to all feature values in the area overlapping with the first feature map FM1. As the first feature map FM1 and the weight map WM are convolved, one channel of the second feature map FM2 may be generated. In FIG. 2A, one weight map WM is displayed, but in practice, a plurality of weight maps are convolved with the first feature map FM1, and a plurality of channels of the second feature map FM2 may be generated. In other words, the number of channels in the second feature map FM2 may correspond to the number of weight maps.

The second layer L2 may generate a third feature map FM3 by changing the spatial size of the second feature map FM2. For example, the second layer L2 may be a sampling layer. The second layer L2 may perform up-sampling or down-sampling, and the second layer L2 may select some of the data included in the second feature map FM2. For example, a two-dimensional window WD may be shifted on the second feature map FM2 in units of the size (e.g., 4*4 matrix) of the window WD, and a value of a specific position (e.g., one row and one column) in the area overlapping with the window WD may be selected. The second layer L2 may output the selected data as data of the third feature map FM3. As another example, the second layer L2 may be a pooling layer. In this case, the second layer L2 may select the maximum value of the feature values (or the average value of the feature values) of the overlapping window WD in the second feature map FM2. The second layer L2 may output the selected data as data of the third feature map FM3.

Accordingly, a third feature map FM3 with a spatial size changed from the second feature map FM2 may be generated. The number of channels of the third feature map FM3 and the number of channels of the second feature map FM2 may be the same. On the other hand, according to an embodiment of the disclosure, the calculation speed of the sampling layer may be faster than that of the pooling layer, and the sampling layer may improve the quality of the output image (e.g., in terms of peak signal to noise ratio (PSNR)). For example, the calculation by the pooling layer may have a larger calculation time than the calculation by the sampling layer because the maximum value or the average value must be calculated.

According to an embodiment, the second layer L2 may not be limited to a sampling layer or a pooling layer. For example, the second layer L2 may be a convolution layer similar to the first layer L1. The second layer L2 may generate a third feature map FM3 by convolving the second feature map FM2 with the weight map. In this case, the weight map performing the convolution calculation in the second layer L2 may be different from the weight map WM performing the convolution calculation in the first layer L1.

The Nth feature map in the Nth layer may be created through a plurality of layers, including the first layer L1 and the second layer L2. The Nth feature map may be input to a reconstruction layer located at the backend of the artificial neural network model from which the output data is output. The reconstruction layer may generate an output image based on the Nth feature map. In addition, the reconstruction layer may receive not only the Nth feature map but also a plurality of feature maps such as the first feature map FM1 and the second feature map FM2 and generate an output image based on a plurality of feature maps.

For example, the reconstruction layer may be a convolution layer or a de-convolution layer. Depending on the embodiment, it may be implemented as another kind of layer that can restore the image from the feature map.

FIG. 2B is a block diagram of an electronic device according to an embodiment of the disclosure.

Referring to FIG. 2B, the electronic device 200 (e.g., the electronic device 101 of FIG. 1) may include a processor 220 (e.g., the processor 120 of FIG. 1), a memory 230 (e.g., the memory 130 of FIG. 1). The components included in FIGS. 2A and 2B relate to a portion of the configurations included in the electronic device 200, and the electronic device 200 may also include various other components as shown in FIG. 1.

The memory 230 may temporarily or non-temporarily store data related to the artificial intelligence model. For example, the memory 230 may store data related to the AI model, such as layers, weights, and operations of the AI model, and update the data related to the AI model based on the output value of the AI model. For example, the memory 230 may store the output value of the artificial intelligence model.

The artificial intelligence model according to an embodiment may be a neural network model written in a specified language and including a plurality of layers and/or operations. The artificial intelligence model according to an embodiment may be at least one of various kinds of networks such as a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a fully convolutional network, and a long short-term memory (LSTM) network, and a classification network. The artificial intelligence model according to an embodiment may be trained on the specified data, acquire input data, and generate output data by performing a calculation based on the input data.

The artificial intelligence model according to an embodiment may include an input layer, a hidden layer, and an output layer. The input layer may be related to the input values that are input to the AI model. In the hidden layer, a feature map may be output by performing multiply-accumulate (MAC) calculations and activation calculations on input values. The output layer may be related to the result value of the calculation performed in the hidden layer.

According to an embodiment, the artificial intelligence model may be stored in memory 230. According to an embodiment, the calculation based on the artificial intelligence model may be performed in the processor 220 (e.g., a central processing unit (CPU) and/or a neural processing unit (NPU)).

The processor 220 may perform a calculation based on an artificial intelligence model stored in the memory 230.

The processor 220 according to an embodiment may include at least one processor. For example, the processor 220 may include a central processing unit (CPU) (e.g., the main processor 121 of FIG. 1) and/or a neural processing unit (NPU) (e.g., the auxiliary processor 123 of FIG. 1).

The processor 220 according to an embodiment may include a compiler 210.

According to an embodiment, the compiler 210 may compile source code written in a particular language into a target code that can be processed in a target program and/or target hardware. For example, the compiler 210 may recall (or load) an AI model from memory 230 and compile the AI model into a binary usable in the processor 220.

The processor 220 according to an embodiment may identify the activation function included in the compiled artificial intelligence model.

For example, the processor 220 may activate the first function and/or the second function in response to including a first type function in the activation function of the compiled AI model.

According to an embodiment, the first type function may be a Rectified Linear Unit (ReLU) function. The ReLU function is a function that outputs 0 if the input value is negative and outputs as it is if the input value is positive.

The processor 220 according to an embodiment may output a feature map by performing a multiply-accumulate (MAC) calculation and an activation calculation on the input value in the hidden layer.

The MAC calculation may be a calculation that multiplies the input value and the corresponding weight, respectively, and sums the multiplied values. The activation calculation may be a calculation that inputs the result of the MAC calculation into the activation function and outputs the result value.

The processor 220 according to an embodiment may omit the calculation for a specified value included in the input of the hidden layer.

For example, the first function may be a zero-skipping function. The zero-skipping function may be a function of omitting the MAC calculation for 0 included in the input value (e.g., feature map, result value of the previous hidden layer).

For example, the second function may be a feature map compression function. The feature map compression function may be a function in which the processor extracts a non-zero value for the output value (e.g., feature map) of the hidden layer and compresses the feature map.

The artificial intelligence model (not shown) according to an embodiment may include an input layer, a hidden layer, and an output layer.

The input layer is a layer related to the input value input to the AI model.

In the hidden layer, a feature map may be output by performing multiply-accumulate (MAC) calculations and activation calculations on input values.

The MAC calculation may be a calculation that multiplies the input value and the corresponding weight, respectively, and sums the multiplied values.

The activation calculation may be a calculation that inputs the result of the MAC calculation into the activation function and outputs the result value. The activation function may be various types. For example, the activation function may include, but is not limited to, a Sigmoid function, a Tangent function, a ReLU function, a Leaky ReLU function, a Maxout function, and/or an ELU function.

The hidden layer may consist of at least one layer. For example, when the hidden layer is composed of a first hidden layer and a second hidden layer, the first hidden layer outputs a feature map by performing MAC calculation and activation calculation based on the input value of the input system, and the feature map, which is the result value in the first hidden layer, may be an input value in the second hidden layer. The second hidden layer may perform MAC calculation and activation calculation based on the feature map, which is the result value of the first hidden layer.

The output layer may be a layer related to the result value of the calculation performed in the hidden layer.

In the description related to FIG. 2B, at least some of the portions shown as included in the processor 220 may be SW modules running in the processor 220, and in this case the operations performed by the corresponding portions may be understood as the operation of the processor 220.

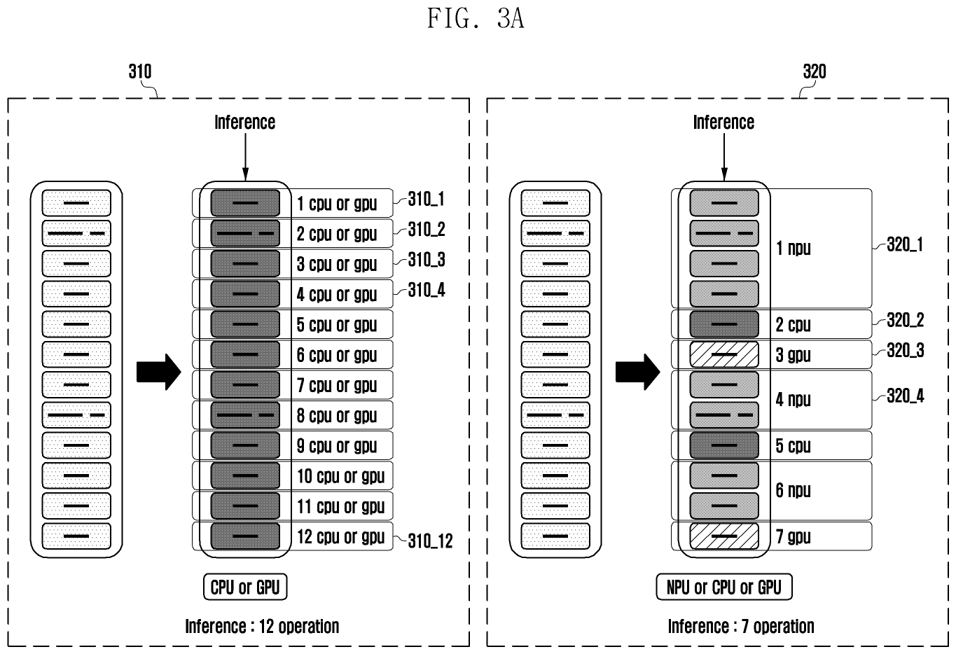

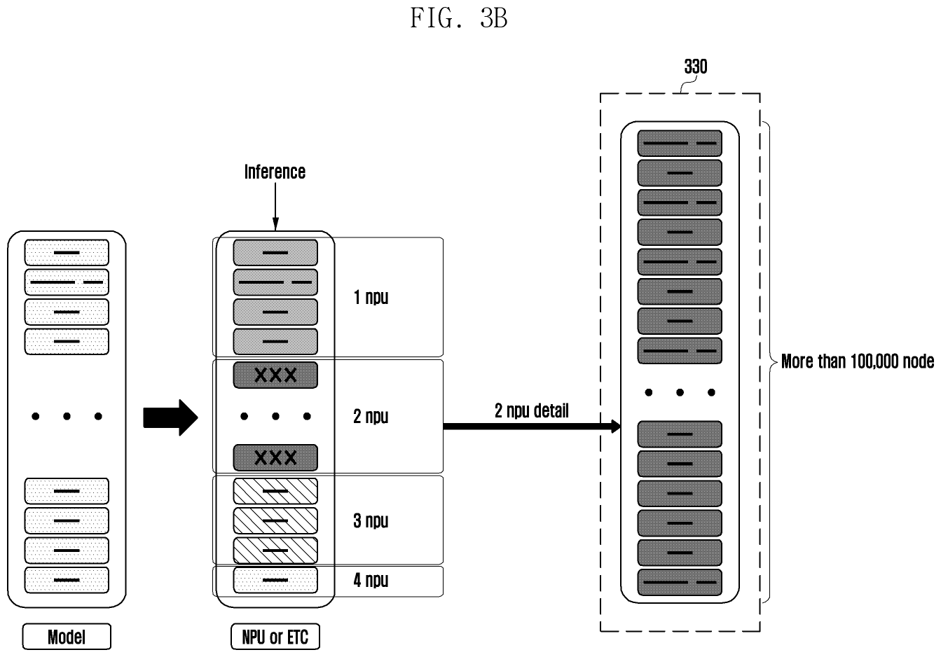

FIGS. 3A and 3B illustrate the process of sequentially inferring through the partition of each node in an artificial intelligence learning model according to various embodiments of the disclosure.

Referring to 310 of FIG. 3A, the AI model may perform one calculation sequentially with each node as an execution unit in the case of an XPU (e.g., CPU, GPU). For example, referring to 310 of FIG. 3A, the result may be sent to the second XPU 310_2 after performing the calculation on the first XPU 310_1. The second XPU 310_2 may receive the calculation result of the first XPU 310_1, perform the calculation based thereon, and send the result to the third XPU 310_3. The third XPU 310_3 may receive the calculation result of the second XPU 310_2, perform the calculation based thereon, and send the result to the fourth XPU 310_4. Referring to 310 of FIG. 3A, this process may be repeated up to the 12th XPU 310_12, and the 12th XPU 310_12 may output the final calculation result. The number of XPUs is just one example and is not limited to this.

Referring to 320 of FIG. 3A, the AI model may group a plurality of calculations executed on all devices XPUs, (e.g., GPUs, NPUs) performing internal paths (compiling or interpreting) into the same group. An XPU with an internal path may change external data into an executable image in the core in the XPU using internal compilation. The AI model may process a plurality of calculations grouped in the same group at once. For example, referring to 320 of FIG. 3A, the first NPU 320_1 may execute four calculations as a bundle. Thereafter, the first NPU 320_1 may transmit the calculation result to the second CPU 320_2. The second CPU 320_2 may transmit the result to the third GPU 320_3 after the calculation. The third GPU 320_3 may transmit the result to the fourth NPU 320_4 after the calculation. The fourth NPU 320_4 may execute two calculations as a bundle. In this way, the AI model may derive the final calculation result relatively faster than referring to 310 of FIG. 3A. The number of calculations or the number of XPUs to be executed is not limited to this and may vary depending on the configuration.

Referring to 330 of FIG. 3B, the number of nodes that need to be executed may vary depending on the configuration. Referring to 330 of FIG. 3B assumes 100,000 nodes. In this case, there is a limitation in the performance of the hardware (e.g., memory size, speed of operating frequency), so that the calculation processing speed may be slow, or the calculation may not be possible. Problems with hardware performance may become more serious because the number of calculations increases and the number of nodes increases as the data grows and becomes more complex. Hereinafter, an operation method of an electronic device that appropriately partitions between nodes to overcome problems caused by the performance of such hardware will be described.

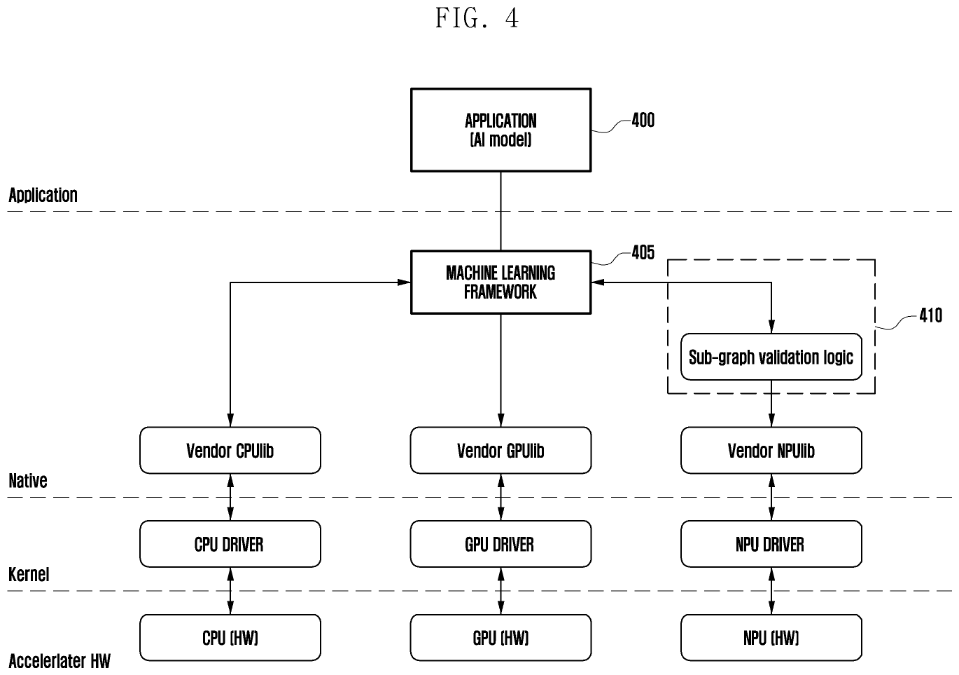

FIG. 4 illustrates a layer of an electronic device that automatically generates partitions between nodes for calculation according to an embodiment of the disclosure.

Referring to FIG. 4, the processor (e.g., the processor 220 of FIGS. 2A and 2B) may further include a sub-graph validation logic 410 of machine learning framework 405 on the backend of the application 400. The processor 220 may identify in advance whether a problem arising in the execution process of the calculation can be solved using the sub-graph validation logic 410. That is, the processor 220 may identify in advance whether the hardware constraint may be resolved and the calculation may be performed normally by assuming a situation in which the sub-graph is generated using the sub-graph validation logic 410. Sub-graph may specifically refer to the process of grouping nodes into groups and dividing them into partitions.

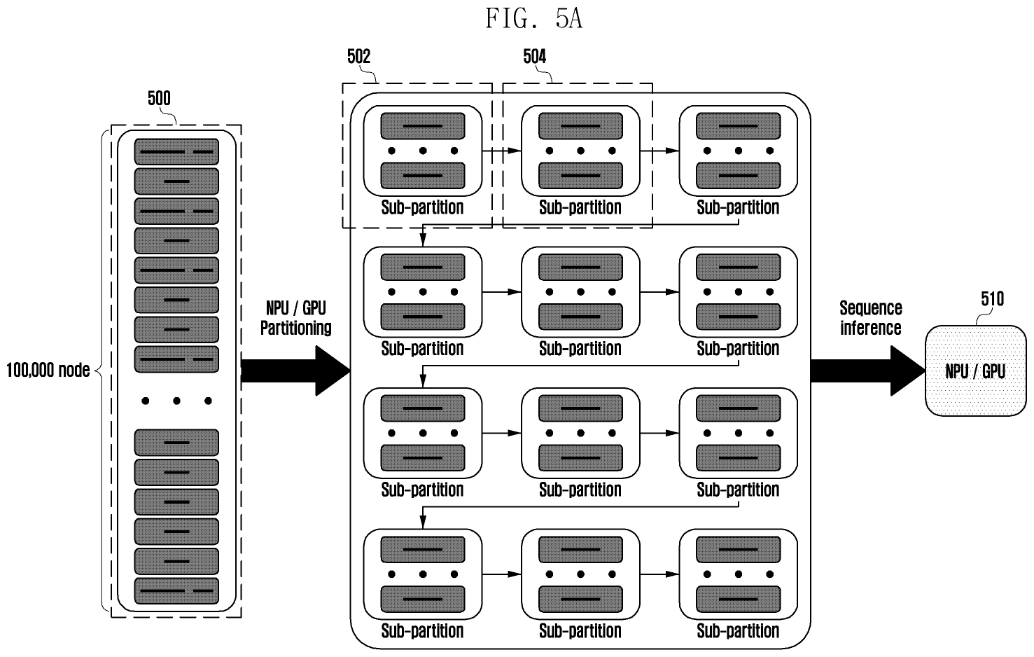

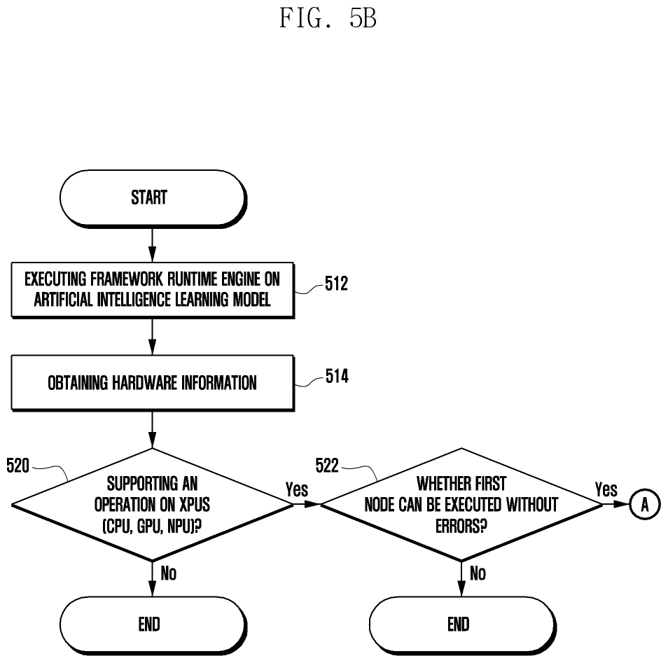

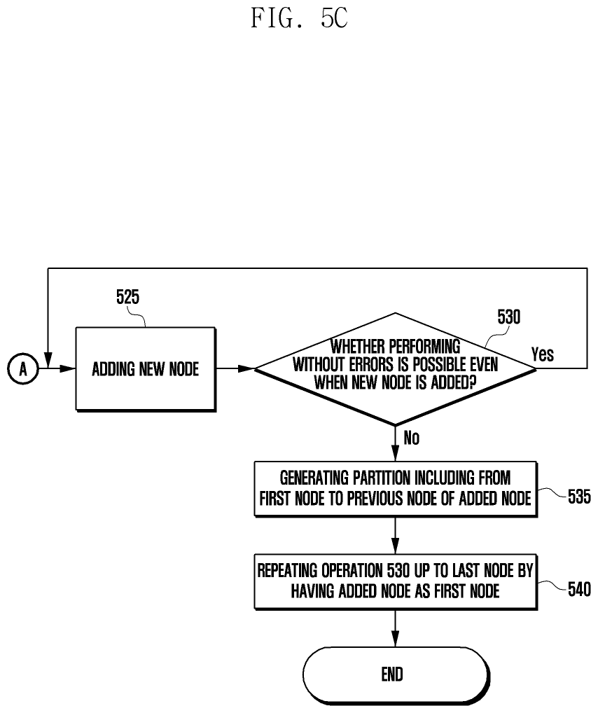

A partition may refer to a bundle of nodes running on a particular XPU (e.g., CPU, GPU, NPU). For example, processor 220 may create a bundle with a partition from node 1 to node 999. The processor 220 may determine whether the inference of the AI learning model can be executed well when one node (e.g., node 1000) is added to it. Since there is a limitation of the memory 130 size, the number of nodes that can be executed at one time may be limited. The processor 220 may separate the nodes into an appropriate number using a partition in consideration of the limitation of the memory 130 size. Here, the appropriate number of nodes may mean the number of nodes that operate without errors in performing the calculation of the artificial intelligence learning model. The processor 220 may identify whether it operates without errors when performing the calculation of the artificial intelligence learning model by adding nodes one by one. Here, the operation of identification may mean an operation to verify that the calculation of the artificial intelligence learning model works without errors when performing the calculation. Alternatively, the operation of identification may mean a prediction operation based on the calculation of the processor 220. The processor 220 may perform simulations one by one in advance for each node to determine whether the calculation can be executed, and determine the corresponding node as a partition criteria when a node, in which the calculation cannot be executed, occurs. The processor 220 may perform the calculation without problems despite hardware limitation by grouping the nodes in which the calculation can be executed by a partition. This will be described in detail in FIGS. 5A to 5C, 6A, 6B, and 7.

The processor 220 may identify the constraint on the currently used XPU. The constraint may include, for example, at least one of weight information, quantization/dequantization weight information, or parameter information of a node.

The weight information of the node, for example, may mean information necessary for calculation with input data, as parameter information for performing an operation such as Conv2d. The quantization/dequantization weight information of the node, for example, may mean information for converting the inference data type of the operation such as FP32<->INT32 or FP32<->INT8. The parameter information of the node, for example, may mean operation shape information, axis for operation execution, padding option, bias, and threshold. In addition, information such as a memory handle for memory recycling may be further included.

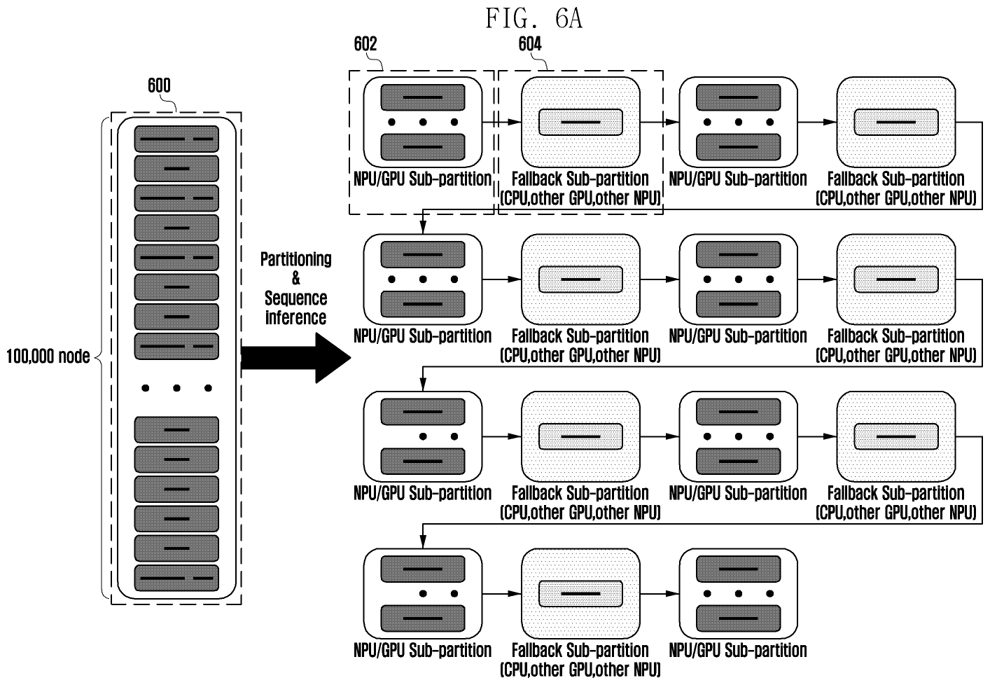

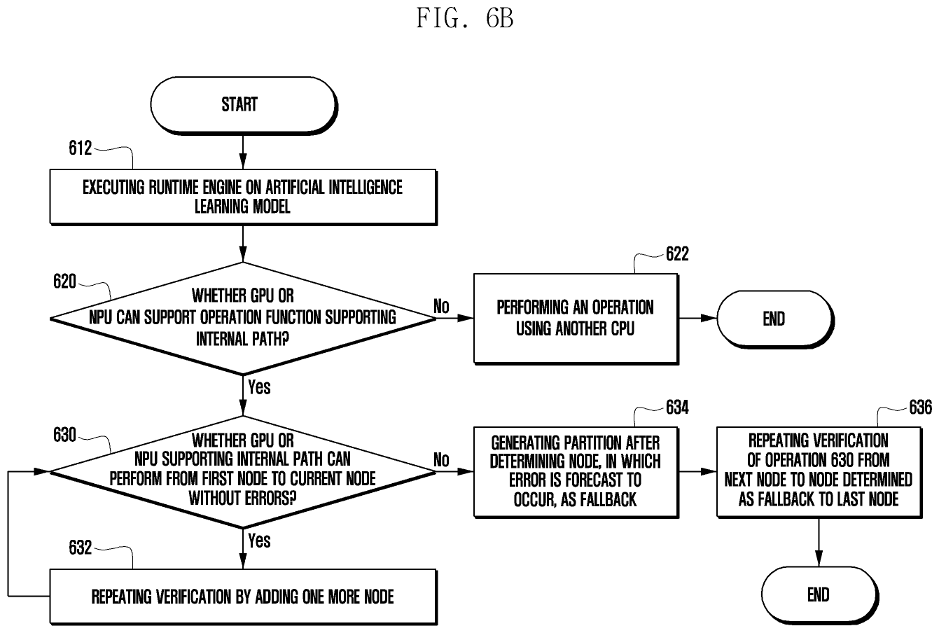

The operation method of the NPU or GPU having an internal path may be a task method in the same way as the CPU. The task method may be operated based on the context. The resources available on the task divided by partition on the artificial intelligence learning model may be the same as the memory resources of the NPU or GPU currently in use. For this reason, if a sub-graph is created in consideration of memory resources, the limitation of memory size may be overcome and the artificial intelligence learning model may be operated without problems. In FIGS. 5A to 5C, 6A, and 6B, the process of overcoming the limitation of memory size through a plurality of partitioning of an artificial intelligence learning model will be described.

FIG. 5A illustrates a first embodiment that automatically generates partitions between nodes for calculation according to an embodiment of the disclosure. FIG. 5B illustrates the process for the first embodiment as a flowchart according to an embodiment of the disclosure. FIG. 5C illustrates the process for the first embodiment as a flowchart according to an embodiment of the disclosure.

Referring to FIG. 5A, a processor (e.g., the processor 220 of FIGS. 2A and 2B) may execute a learning model 500 having 100,000 nodes. The number of nodes is only an example and may vary depending on the configuration. Referring to FIG. 5A, a situation of being executed in all devices (XPUs) performing an internal path (compiling or interpreting) is assumed. The processor 220 may separate 100,000 nodes using sub-partitions 502 and 504. The processor 220 may operate the learning model 500 using partitions 502 and 504 regardless of the constraint of the hardware (e.g., the memory 130). The processor 220 may use all devices (XPUs) 510 that perform an internal path (compiling or interpreting) to form partitions 502 and 504. The processor 220 may simulate whether the learning model 500 works well without errors when the partition 502 and 504 are formed using the NPU or the GPU 510, and the partition 502, 504 may be formed based on the simulation result. An error may mean, for example, a situation in which a graph composed of a single partition is impossible to execute because of a limitation of memory size. Graphs composed in the form of a single partition may require a memory relatively larger than the memory size. In this case, the processor 220 may be difficult to perform compilation normally. To prevent such an error, the processor 220 may divide a plurality of nodes using at least one partition, overcome the limitation of memory size, and perform compilation normally.

The electronic device (e.g., the electronic device 101 of FIG. 2B) according to this document may be simulated assuming a situation in which the sub-partition has been formed before the sub-partition is formed. Based on the simulation results, the electronic device 101 may determine differently the position where the sub-partition is generated and the number of nodes included on one partition. The electronic device 101 may not need to identify whether the learning model 500 works well without errors in the current hardware after the time when at least one partition is generated by performing a simulation in advance before generating at least one partition. In FIG. 5A, a situation with 100,000 nodes and 12 sub-partitions is described, but this is only an example and may vary depending on the configuration.

An open-source-based machine learning framework may judge whether a calculation can be performed on a particular XPU or not. In other words, the machine learning framework may control nodes only in two situations which are performable or not performable. For example, the machine learning framework may receive a result that the calculation from the 1st node to the 1000th node can be performed, and the calculation cannot be performed when the 1001st node is included. In this case, the machine learning framework can deploy continuously from the 1st node to the 1000th node and separate using one partition, and the 1001st node can be separated from the 1000th node. The machine learning framework may determine whether a calculation can be performed by grouping several more nodes in a row based on the 1001st node. For example, the machine learning framework may receive a result that a calculation can be performed up to the 4030th node based on the 1001st node, and that the calculation cannot be performed if the 4031st node is included. In this case, the machine learning framework can be continuously deployed from the 1001st node to the 4030th node and separated using one partition, and the 4031st node can be deployed by being separated from the 4030th node.

Machine learning frameworks may also perform partitioning on their own without modification. In this case, since the machine learning framework can control nodes only in two situations which are performable or not performable, specific nodes may be separated as in FIG. 6A, rather than forming a continuous partition as in FIG. 5A. This will be described in FIG. 6A. In a machine learning model, nodes can be hierarchically structured. The order of nodes in a machine learning model can be determined based on the flow from the input layer to the output layer. Each layer can consist of one or more nodes. The order of nodes can be determined differently depending on the structure of the machine learning model and the learning algorithm. Each node can perform learning or calculation based on the information received from the nodes in the previous layer. Each node can pass the learned information to the next node in order.

FIGS. 5B and 5C are flowcharts illustrating the process for the first embodiment of FIG. 5A.

The operations described through FIGS. 5B and 5C may be implemented based on instructions that may be stored in a computer recording medium or a memory (e.g., the memory 130 of FIG. 1). The illustrated method may be executed by the electronic device described above through FIGS. 1, 2A, 2B, 3A, 3B, and 4 (e.g., the electronic device 101 of FIG. 1), and the technical features described above will be omitted below. The order of each operation of FIG. 5B may be changed, some operations may be omitted, and some operations may be performed at the same time.

In operation 512, the processor 220 may execute a framework runtime engine on the artificial intelligence learning model.

In operation 514, the processor 220 may obtain information (e.g., memory size, number of clocks) of hardware for executing the artificial intelligence learning model. The processor 220 may partition when executing learning on a framework based on the information of the obtained hardware. Learning can be carried out by creating a graph, and it may be difficult to execute in the form of a graph that includes all nodes because of hardware constraints. Partitioning may be necessary to solve this problem.

In operation 520, the processor 220 may identify whether the target processor (XPU (e.g., CPU, GPU, NPU)) supports an operation. Each XPU (CPU, GPU, NPU) may have different operation supported. For example, a CPU may support a relatively larger number of operation than a GPU or a NPU. In this case, the processor 220 may execute an operation using a CPU other than a GPU or a NPU. Alternatively, the processor 220 may obtain information about the operation in the framework.

Based on the support of an operation on the target processor (e.g., CPU, GPU, NPU) in operation 520, the processor 220 in operation 522 may determine whether the first node is executable without errors. If No in operation 522, the processor 220 may end the operation based on the inability of the first node to execute without errors. if Yes in operation 522, the processor 220 may add a new node (e.g., the Nth node) in operation 525 based on the fact that the first node can be executed without errors.

In subsequent operation 530, the processor 220 may identify whether it can execute without errors up to the current node (e.g., the Nth node). The processor 220 may simulate whether it is possible to execute without errors up to the current node (Nth node) using the target processor.

If Yes in operation 530, the processor 220 may repeat the simulation by increasing the number of nodes by one more in operation 525 based on the fact that it is possible to execute without errors up to the current node (Nth node).

If No in operation 530, the processor 220 may create a partition in operation 535 by grouping up to the previous node (N−1st node) of the current node based on the fact that it is impossible to execute without errors up to the current node (Nth node).

If No in operation 530, the processor 220 may create a partition in operation 535 by grouping up to the previous node (Nth node) of the current node based on the fact that it is impossible to execute without errors up to the current node (N+1st node).

If No in operation 530, the processor 220 may repeat operation 530 and operation 540 to the last node to complete partition creation. As mentioned above, the electronic device 101 may not need to identify whether the learning model 500 works well without errors in the current hardware after the time when at least one partition is generated by performing a simulation in advance before generating at least one partition.

FIG. 6A illustrates a second embodiment that automatically generates partitions between nodes for calculation according to an embodiment of the disclosure. FIG. 6B illustrates the process for the second embodiment as a flowchart according to an embodiment of the disclosure.

Referring to FIG. 6A, a processor (e.g., the processor 220 in FIGS. 2A and 2B) may execute a learning model 600 having 100,000 nodes. The number of nodes is only an example and may vary depending on the configuration. In FIG. 6A a situation of being executed in all devices (XPUs) performing an internal path (compiling or interpreting) is assumed. In addition, the processor 220 may execute a node that is not running on all devices (XPUs) that perform an internal path (compiling or interpreting) using the CPU as the target processor. The processor 220 may separate 100,000 nodes using sub-partition 602 and fallback sub-partition 604. The processor 220 may operate the learning model 600 using partitions 602 and 604 regardless of the constraint of the hardware (e.g., memory 130). The processor 220 may utilize any device (XPU) (e.g., NPU or GPU containing an internal path) that performs an internal path (compiling or interpreting) to form the sub-partition 602. The processor 220 may use a CPU or another NPU or GPU to form the fallback sub-partition 604. When the sub-partition 602 is formed using the NPU or the GPU, the processor 220 may simulate whether the learning model 500 works well without errors, and the partition 602 may be formed based on the simulation result. The sub-partition 602 may include nodes that can be executed on an NPU or GPU having an internal path. The fallback sub-partition 604 may include one node that is not executed on an NPU or GPU having an internal path. There is a difference in that the sub-partition 602 is executed on an NPU or GPU having an internal path, and the fallback sub-partition 604 is executed on an NPU or GPU that is different from the CPU or the previous sub-partition 602. One node included in the fallback sub-partition 604 may be separated by the fallback sub-partition 604 when the NPU or GPU having an internal path does not support an operation. One node included in the fallback sub-partition 604 may be separated by the fallback sub-partition 604 when all devices (XPUs) (e.g., NPUs or GPUs with internal paths) performing internal paths (compiling or interpreting) cannot execute a plurality of nodes because of the limitation of memory size.

As described in FIG. 5A, the machine learning framework may perform partitioning on its own without modification. In this case the machine learning framework may control the nodes only in two situations: the calculation can be performed and the calculation cannot be performed. For example, the machine learning framework may perform calculations from the 1st node to the 999th node and may receive a result that the calculation cannot be performed when the 1000th node is included. In this case, the processor 220 may deploy continuously from the first node to the 999th node using a machine learning framework and separate them using one partition, and the 1000th node may be deployed by being separated from the 999th node. Here, the machine learning framework may control nodes only in two situations: the calculation can be performed and the calculation cannot be performed. Thus, the processor 220 may bundle from the 1st node to the 999th node as a partition using a machine learning framework, and the 1000th node can be created as a separate partition. Then, for the 1001st node, it may be determined whether it is possible to perform the calculation by adding nodes one by one as in the first node.

FIG. 6B illustrates the process for the second embodiment of FIG. 6A as a flowchart. The operations described through FIG. 6B may be implemented based on instructions that may be stored in a computer recording medium or a memory (e.g., the memory 130 of FIG. 1). The illustrated method may be executed by the electronic device described above through FIGS. 1, 2A, 2B, 3A, 3B, and 4 (e.g., the electronic device 101 of FIG. 1), and the technical features described above will be omitted below. The order of each operation of FIG. 6B may be changed, some operations may be omitted, and some operations may be performed at the same time.

In operation 612, the processor 220 may execute a framework runtime engine on the artificial intelligence learning model.

In operation 620, the processor 220 may determine whether all devices (XPUs) (e.g., GPUs or NPUs that support internal paths) that perform internal paths (compiling or interpreting) support the operation. The processor 220 may execute an operation 622 using another CPU or using another GPU or NPU based on the fact that the GPU or the NPU does not support the operation function.

The processor 220 may execute operation 630 based on identifying that the GPU or the NPU supporting the internal path in operation 620 supports an operation. In operation 630, the processor 220 may identify whether it can be executed from the first node to the current node without errors in a GPU or a NPU that supports an internal path. If the processor 220 identifies that the first node is running without errors, the processor 220 may repeat the identification by adding one more node in operation 632. For example, if it is determined that an error occurred on the Nth node while running without errors up to the N−1st node, the processor 220 may divide the Nth node into partitions. The processor 220 may divide from the first node to the N−1st node into sub-partitions, and the Nth node may be divided into fallback sub-partitions. Nodes separated by sub-partitions may be executed on GPUs or NPUs that support internal paths. Nodes separated by fallback sub-partitions may be executed on CPUs or other GPUs or NPUs that do not support internal paths. An error means a runtime error and may occur because of hardware (e.g., memory size) constraints. Hardware constraints are described in FIGS. 3A and 3B.

The processor 220 may divide the Nth node into a fallback sub-partition in operation 634 when it is determined that an error occurred on the Nth node. In subsequent operation 636, the processor 220 may repeat the identification of operation 630 for the next N+1st node. The processor 220 may repeat the identification for the N+1st node and the N+2 node, and may end the operation if the last node is identified.

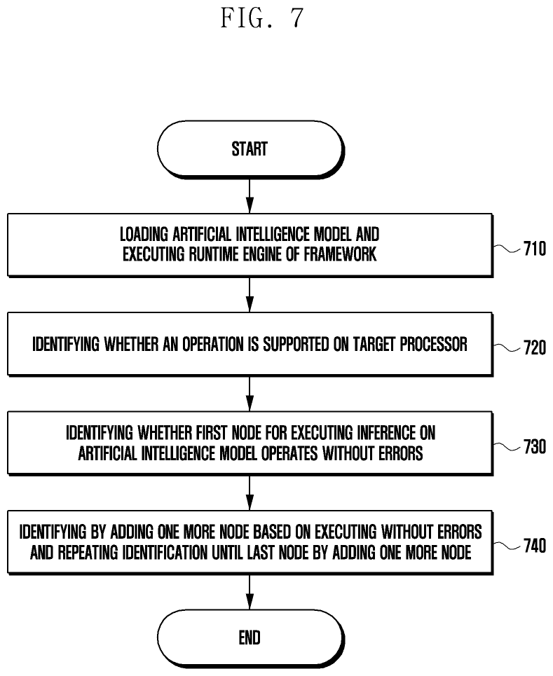

FIG. 7 illustrates a flowchart of a method of performing calculation of an electronic device according to an embodiment of the disclosure.

The operations described through FIG. 7 may be implemented based on instructions that may be stored in a computer recording medium or a memory (e.g., the memory 130 of FIG. 1). The illustrated method may be executed by the electronic device described above through FIGS. 1, 2A, 2B, 3A, 3B, 4A and 4 (e.g., the electronic device 101 of FIG. 1), and the technical features described above will be omitted below. The order of each operation of FIG. 7 may be changed, some operations may be omitted, and some operations may be performed at the same time.

In operation 710, a processor (e.g., the processor 220 in FIG. 2B) may load an artificial intelligence model and execute the runtime engine of the framework. The processor (220) can incorporate a pre-trained artificial intelligence model into the memory (130) through loading. A runtime engine can refer to the software that provides necessary services while a program is running. The runtime engine of an artificial intelligence model (such as a machine learning model) may refer to the software necessary for the trained model to operate in practice.

In operation 720, the processor 220 may identify whether it supports an operation on the target processor. The target processor may include, for example, a CPU, an NPU, or a GPU. In an embodiment, the CPU may support relatively more operations than the GPU or the NPU. The processor 220 may execute an operation using the CPU when the GPU or the NPU does not support the operation. Alternatively, the processor 220 may obtain information about the operation in the framework.

In operation 730, the processor 220 may identify whether the first node for executing inference on the artificial intelligence model operates without errors. Based on supporting an operation on the target processor, the processor 220 can identify whether the first node for executing inference on the artificial intelligence model operates without errors. An error may mean, for example, a situation in which a graph composed of a single partition is impossible to execute because of a limitation of memory size. The graph composed of a single partition may require a memory relatively larger than the memory size. In this case, the processor 220 may be difficult to perform compilation normally. To prevent such an error, the processor 220 may divide a plurality of nodes using at least one partition, overcome the limitation of memory size, and perform compilation normally.

In operation 740, the processor 220 may perform the identification by adding one more node based on the identification being passed, and repeat the identification until the last node. For example, the processor 220 may form a first group by creating a partition from the first node to the N−1st node for which the identification is passed, based on the fact that the identification is not passed at the Nth node. N may mean a natural number, and the range may vary depending on the configuration. The processor 220 may form a second group by creating a partition for the Nth node for which the identification is not passed. The processor 220 may repeat the identification whether the inference on the artificial intelligence model is executed without errors from the N+1 node to the last node.

According to an embodiment, the nodes included in the first group may be executed by any device (XPU) that performs an internal path (compiling or interpreting) (e.g., a neural processing unit (NPU) or a graphics processing unit (GPU) including an internal path). This may mean the sub-partition 602 of FIG. 6A.

According to an embodiment, a node included in the second group may be executed by a different device from the first group. This may mean the fallback sub-partition 604 of FIG. 6A.

According to an embodiment, the processor 220 may be controlled to support an operation function using any of another CPU, NPU, or GPU based on the fact that the target processor does not support the operation.

According to an embodiment, the processor 220 may perform an identification whether the inference can be executed without errors using the target processor in a newly added node even if the newly added node is included.

According to an embodiment, the processor 220 may perform an identification using the target processor, and based on the determination that it is difficult to execute inference without errors when including a newly added node, a partition may be created between the old nodes and the newly added nodes.

According to an embodiment, the processor 220 may store the compiled result (e.g., kernel or image) in memory 130 for use in the target processor based on the completion of compilation of the artificial intelligence model. Here, the kernel can mean the result of compilation. Compilation may refer to the process by which the processor 220 interprets a particular file at the backend and changes it into a form that can be operated in the core of the processor 220.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure, has been shown and described with reference to various embodiments thereof, it will be understood by those skilled in the art that various changes in form and details may be made therein without departing from the spirit and scope of the disclosure. as defined by the appended claims and their equivalents.

What is claimed is:

1. An electronic device comprising:
memory storing artificial intelligence models and one or more programs including computer-executable instructions; and
one or more processors,
wherein the one or more programs include computer-executable instructions that, when executed by the one or more processors, cause the electronic device to:
load the artificial intelligence models stored in the memory and execute a runtime engine of a framework,
identify whether an operation function is supported on a target processor,
identify whether a first node for executing an inference on the artificial intelligence models operate without errors based on supporting the operation function on the target processor,
identify whether a next node operates without error by adding one more node in case that the first node operates without errors,
form a first group by creating a partition from the first node to an identified N−1st node based on the identification that an error occurred on an Nth node, and
form a second group by creating a partition for the Nth node on which the error occurred.

2. The electronic device of claim 1,
wherein the target processor corresponds to any one of devices (XPUs) performing compiling and/or interpreting,
wherein the nodes included in the first group are executed by the devices (XPUs) performing compiling and/or interpreting,
wherein the nodes included in the second group are executed by devices other than the first group among the devices (XPUs) performing compiling and/or interpreting, and
wherein the one or more programs further include computer-executable instructions that, when executed by the one or more processors, cause the electronic device to:
repeat identifying whether the inference on the artificial intelligence models is executed without errors from an N+1 node to the last node.

3. The electronic device of claim 1, wherein the one or more programs further include computer-executable instructions that, when executed by the one or more processors, cause the electronic device to:
control the operation function using any one of devices (XPUs) for compiling and/or interpreting in case that the target processor does not support the operation function.

4. The electronic device of claim 1, wherein the one or more programs further include computer-executable instructions that, when executed by the one or more processors, cause the electronic device to:
identify whether an inference can be executed without errors even if the added one more nodes are included using the target processor in a situation where a new node is added.

5. The electronic device of claim 4, wherein the one or more programs further include computer-executable instructions that, when executed by the one or more processors, cause the electronic device to:
perform the identification using the target processor; and
create a partition between old nodes and the added one more nodes based on a determination that it is difficult to execute the inference without errors if the added one more nodes are included.

6. The electronic device of claim 1, wherein the one or more programs further include computer-executable instructions that, when executed by the one or more processors, cause the electronic device to:
store a kernel compiled or interpreted for use in the target processor based on a completion of a compilation of the artificial intelligence models in the memory.

7. An electronic device comprising:
memory storing artificial intelligence models and one or more programs including computer-executable instructions; and
one or more processors,
wherein the one or more programs includes computer-executable instructions that, when executed by the one or more processors, cause the electronic device to:
load the artificial intelligence models stored in the memory and execute a runtime engine of a framework,
obtain information about hardware of the electronic device,
identify whether an operation function is supported on a target processor,
identify whether a first node for executing an inference on the artificial intelligence models operate without errors based on supporting the operation function on the target processor,
repeat the identification until a last node by adding one more nodes based on the identification being successful,
form a first group by creating a partition from the first node to an identified N−1st node based on the identification not being successful in a Nth node,
identify whether the Nth node operates without errors,
repeat the identification until the last node by adding the one more nodes based on the Nth node operating without errors,
form a second group by creating a partition from the Nth node to an identified K−1st node based on a Kth node on which the error occurred, and
repeat the identification until the last node whether the error occurs,
wherein the N and the K are natural numbers, and
wherein the K is greater than the N.

8. The electronic device of claim 7, wherein the information about the hardware on the electronic device includes a size of the memory and a speed of an operating frequency.

9. The electronic device of claim 8, wherein the one or more programs further include computer-executable instructions that, when executed by the one or more processors, cause the electronic device to:
control an operation using any one of devices (XPUs) for compiling and/or interpreting in case that the target processor does not support the operation function.

10. The electronic device of claim 8, wherein the one or more programs further include computer-executable instructions that, when executed by the one or more processors, cause the electronic device to:
identify whether an inference can be executed without errors even if the added one or more nodes are included using the target processor in a situation where a new node is added.

11. The electronic device of claim 10, wherein one or more programs further include computer-executable instructions that, when executed by the one or more processors, cause the electronic device to:
perform the identification using the target processor; and
create a partition between old nodes and the added one or more nodes based on a determination that it is difficult to execute the inference without errors if the added one or more nodes are included.

12. The electronic device of claim 8, wherein one or more programs further include computer-executable instructions that, when executed by the one or more processors, cause the electronic device to:
store a compiled result in the memory so that it can be used in the target processor based on a completion of a compilation of the artificial intelligence models, and the compiled result contains a kernel or an image.

13. One or more non-transitory computer-readable storage media storing one or more programs including computer-executable instructions that, when executed by one or more processors of an electronic device, cause the electronic device to perform operations, the operations comprising:
loading an artificial intelligence model stored in memory and executing a runtime engine of a framework;
identifying whether an operation is supported on a target processor;
identifying whether a first node for executing an inference on the artificial intelligence model operates without errors based on supporting the operation on the target processor;
identifying whether a next node operates without error by adding one more node in case that the first node operates without errors;
forming a first group by creating a partition from the first node to an identified N−1st node;
forming a second group by creating a partition for an Nth node on which an error occurred; and
storing instructions that repeatedly identify whether the inference is executed without errors on the artificial intelligence model from an N+1th node to the last node.

14. The one or more non-transitory computer-readable storage media of claim 13,
wherein the target processor corresponds to any one of devices (XPUs) performing compiling and/or interpreting,
wherein the nodes included in the first group are executed by the devices (XPUs) performing compiling and/or interpreting, and
wherein the nodes included in the second group is executed by a device different from the first group among the devices (XPUs) performing compile and/or interpreting,
wherein the devices (XPUs) include at least one of a central processing unit (CPU) or a graphical processing unit (GPU).

15. The one or more non-transitory computer-readable storage media of claim 13, the operations further comprising:
identifying whether the inference is executed using the target processor without errors even if the added one or more nodes are included.
